(19) United States
(12) Patent Application Publication
(10) Pub. No.: US 2016/0306616 A1
(43) Pub. Date: Oct. 20, 2016

(54) FIRMWARE UPDATE BY USB CC

(71) Applicant: Microsoft Technology Licensing, LLC, Redmond, WA (US)

(72) Inventor: Tatu Tomppo, Pertteli (FI)

(21) Appl. No.: 14/690,957

(22) Filed: Apr. 20, 2015

(51) Int. Cl. G06F 9/445; G06F 13/42

(52) U.S. Cl. CPC G06F 8/65; G06F 13/4282

(57) ABSTRACT

A firmware update of a USB device is described. In an example, a method comprises: communicating from a first device to a second device by a configuration channel of a universal serial bus; identifying, by the first device, that the second device supports a firmware update mode for an update of a firmware of the second device; commanding, by the first device, the second device to enter the firmware update mode; receiving, by the first device, information of the firmware from the second device; based on the received firmware information, obtaining, by the first device, the update of the firmware; and sending, by the first device, the update of the firmware to the second device, wherein the steps of identifying, commanding, receiving, and sending are conducted by the communication via the configuration channel of the universal serial bus. In other examples, a computer program product and a device are discussed along with the features of the method.

### BACKGROUND

The universal serial bus, USB, standard provides a universal interface for a computing device to connect to another device that may include universal plug-and-play and relative ease-of-use aspects. Herein another USB device may be referred to as a USB peripheral device as well. For example, the USB device may be a master and the peripheral device a slave. The other USB device may include devices such as chargers, docking stations, printers, scanners, keyboards, a mouse, joysticks, digital cameras, digital video cameras, data acquisition devices, modems, speakers, storage devices such as ZIP drives, or any other peripheral or computing device.

Traditionally, firmware of devices receives upgrades, for example from a server. Normally, the USB peripheral device could be updated, for example so that USB memory stick, with a preloaded firmware upgrade, is connected to the peripheral device before start up. Then, a start-up code of the peripheral device identifies the memory stick at boot time, before enabling normal functionality.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

A firmware update of a USB device is described. In an example a method, comprises: communicating from a first device to a second device by a configuration channel of a universal serial bus; identifying, by the first device, that the second device supports a firmware update mode for an update of a firmware of the second device; commanding, by the first device, the second device to enter the firmware update mode; receiving, by the first device, information of the firmware from the second device; based on the received firmware information, obtaining, by the first device, the update of the firmware; and sending, by the first device, the update of the firmware to the second device, wherein the steps of identifying, commanding, receiving, and sending are conducted by the communication via the configuration channel of the universal serial bus.

In other examples, a device and a computer program product are discussed along with the features of the method.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a schematic representation of a computing device connected to another device by a USB connection, in accordance with an illustrative example;

FIG. 2 illustrates a schematic flow diagram of a method for updating a firmware of a USB device, in accordance with an illustrative example;

FIG. 3 illustrates a schematic sequence diagram of a method for updating a firmware of a USB device, in accordance with another illustrative example; and

FIG. 4 illustrates a schematic representation of a computing device in accordance with an illustrative example.

Like references are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples may be described and illustrated herein as being implemented in a USB Type C configuration channel, CC, between USB apparatuses, this is only an example of USB communications between computing apparatuses and not a limitation. As those skilled in the art will appreciate, the present examples are suitable for application in a variety of different Types of USB communications, for example using a USB configuration channel, which is other than the main USB communication channel.

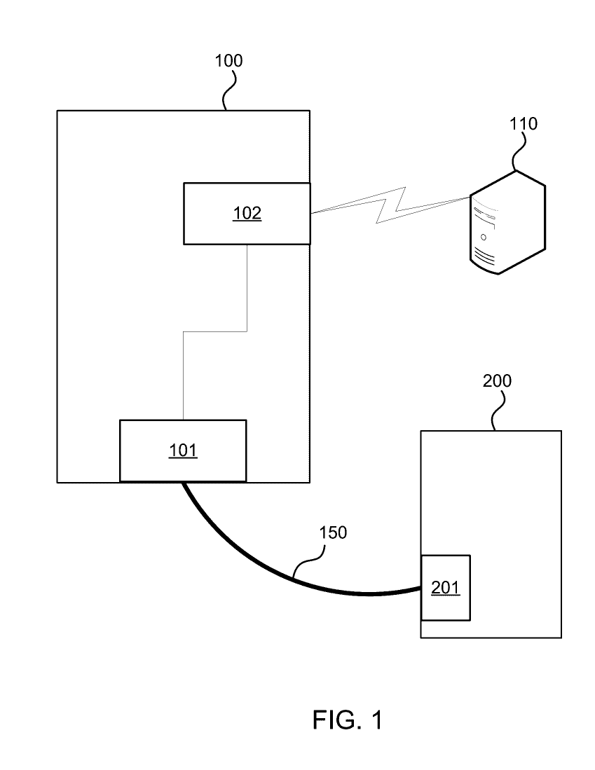

According to an example of FIG. 1, a schematic representation of a computing device 100 which is connected to another device 200 by a USB cable 150 is illustrated. The computing device 100 includes a communication block 102 configured to connect to a server 110. For example, the computing device 100 may connect to the server 110 by the Internet. This may be a wired or wireless connection or a combination of these. For example, the computing device 100 may download or receive a firmware update from the server 110. The computing device 100 includes a USB connection block 101 for connecting via the USB cable 150 to another device 200. The other device 200 may be referred to as a USB peripheral device. For example, the device 100 is configured as a USB master device and other device 200 is configured as a USB slave device. The other device 200 includes USB connection block 201 for connecting to the USB cable 150. The other device 200 may not have an Internet capability, or other similar data connection capability, by which it could download the firmware update itself. This is merely an illustrated example, and it does not matter, which one of the devices is configured to a host device and which one to a slave device from a USB communication point of view. The PD communication channel is used for firmware update in the example. By the example, a default USB host is a downstream facing port, DFP, which initiates PD communication. Port partner is upstream facing port UFP. DFP can perform mode discovery messaging to find out that UFP supports Firmware Update mode. DFP will ask UFP to enter that mode, wherein vendor defined message, VDM, command may be used for the firmware update.

There may be a variety of different Types of computing devices 100 such as a pc, lap top, portable computer, mobile device, mobile phones, tables, phablets, etc. Likewise, the other apparatus 200 may include peripheral devices such as chargers, docking stations, printers, scanners, keyboards, a mouse, joysticks, digital cameras, digital video cameras, data acquisition devices, modems, speakers, storage devices such as ZIP drives, or any other peripheral or computing device.

According to an example, the computing device 100 exchanges information with the other device 200 so that the computing device 100 is aware of a current firmware version of the other device 200. The computing device 100 can decide whether the update is needed, and if so then what is the correct version to download from the server 110. The computing device 100 may also send information to the server 110, which may decide what the correct version is.

It should be noted that the computing device 100 may not necessarily update the other device 200. The computing device 100 updates new FW to the device 200. However, the other device 200 may update itself. For example, the other device 200 may take the new firmware into use at the next boot stage, for example at a start-up stage. Consequently, a firmware of the device 200 is updated.

For example, a mobile phone is connected to a docking station, which has a HUB functionality. The mobile phone can update the docking station firmware automatically, when they are connected by a USB Type C connector. If the docking station device has a HUB interface towards a PC computer or a mobile phone, for example, that interface is not possible to use for the firmware update, because HUB specification does not contain the firmware update procedure. However because the docking station device also has a USB Type C CC lines, those lines may be used for the firmware update without touching the HUB USB interface. According to another example, a mobile phone can update a firmware of a wall changer. The wall changer is connected with the mobile phone by a USB Type C connector.

According to an example, the computing device 100 may have a network connection capability to download a firmware update. For example, the computing device 100 downloads it from the Internet server 110. Furthermore, the computing device 100 may have a capability to execute the update of the firmware on another device 200 via the USB cable 150 connection. For example, the computing device 100 may update the peripheral device 200. The computing device 100 may connect to the peripheral device 200 by a USB configuration channel, CC.

According to an example, another device 200 can receive the firmware update process from the computing device 100. This can be received by the USB configuration channel communications. The other device 200 may not necessarily be configured for Internet communications. Furthermore, the other device 200 may not be configured for USB data lines at all. The USB power management channel and line may be used for the update process. The other device 200 may not necessarily be configured for the normal USB data lines at all. However, the device 200 can take advantage of USB Type C CC lines for obtaining the firmware update.

According to an example, the USB cable 150 may be a USB Type C cable. The USB Type C 1.0 and PD specification 2.0 define a method to allow two devices connected with a USB Type C cable to exchange messages between them using a Type C configuration channel, CC. Typically, two devices use this channel to agree on a mutual power contract, for example which one of the devices provides power and what the voltages and currents available are. There are two CC wires (not shown in figures) in the USB Type C cable 150—one of these is used for communication and the other is used for supplying power. Consequently the CC wire for the communication can be used to communicate the firmware update between the devices.

Communication over CC lines takes place without high or super speed USB data lines. Because of this, communication by the CC lines may take place with devices, which may not support a normal USB host/slave functionality in a USB Type C port, which connects to another device. Consequently, examples may achieve a data communication by using the USB Type C configuration channel, CC, running on one of the CC wires of the cable 150, for updating the firmware, although the peripheral device 200 would not be able to use actual USB data lines at all. Firmware of the other device 200 is typically small, and a low data speed connection may be a feasible connection for performing the update.

For example, docking stations and hub devices may benefit from the possibility to perform the firmware update over the CC lines of the cable 150, because USB data lines are used for a standard hub communication. Normally, the docking station or the hub device could be updated, for example so that a USB memory stick, with preloaded content, is connected to the device before start-up. Then, the docking station or a HUB device start-up code identifies the memory stick at boot time, before enabling normal functionality. According to an example, the usage of the configuration channel, CC, allows the firmware update to take place without a user interaction. For example, some PD capable devices might not have USB data lines at all—for example wall chargers or fixed battery charged power cubes. CC lines may still be used to update firmware of those devices. Firmware of a peripheral device 200 which, for example, has a PD communication capability may be updated. For other examples, a USB Type C—HDMI converter cable might not have USB wires, which are connected inside the cable. A cable might not have USB stack, for example USB functionality, on its hardware. It could be expensive to add such a functionality, merely for update purposes. Also it is not easy to implement a system, where at boot time the connected memory stick contains update software for a HUB, because for the end user it could be very difficult to put the correct firmware to the memory stick. However using PD, it is possible to read device firmware version to select a new firmware image.

Updating firmware of PD communication capable devices may enable better interoperability issues, even with the devices that were not originally intended for data interoperation (without the firmware update). For example, with a new firmware, the device 200 can be re-programmed to work with new devices, even by data interoperation. The peripheral device 200 may become ready for the Internet of Things type communications. According to another example, supported charging voltages or currents of a charger may be altered by the firmware update.

An example uses a USB Type-C cable 150, which includes CC wires. This standard may eventually replace the previous USB standards. With Type-C, USB cable's both ends will be the same, allowing for reversible plug orientation. Users also do not need to worry about plugging it upside down.

The data communication channels and wires of the Type-C USB may support the top speed of 10 Gbps and may have high power output of up to 20V (100 W) and 5A. This may improve charging of the peripheral device 200 via the USB Type C cable 150.

Type-C USB also allows for bi-directional power, so apart from charging the peripheral device 200, when applicable, the peripheral device 200 could also charge a host device 100. Consequently, a power swap may be possible between the primary device 100 and the peripheral device 200.

According to an example, the USB Type-C cable 150 provides a single tiny cable, which can be used for a variety of different devices, for both data and power connections. Type C cable may also be used for transferring Display Port Signal, when needed.

According to an example, a USB Type-C cable 150 has CC lines for power deliver, PD, communication. PD communication is used to exchange power data between two devices. A downstream facing port, DFP, device initializes the communication. An upstream facing port, UFB, device 200 responds. The USB device 100 may be configured as a DFP device and the peripheral device 200 may be configured as an UFP device. It should be noted that the DFP and UFP roles can be switched dynamically, if both devices support it.

The exemplary method and apparatuses may use various control and data messages for the communication protocol via the USB Type C configuration channel, CC, communication. The transfer protocol, such as the USB PD over CC lines, is designed to be very bandwidth effective. For example, only a small amount of bits are reserved to data fields, instead of the whole byte. The data messages may be vendor defined. For example, the data message maximum length may be 240 bits. A vendor defined part may be 207 bits. For example, there are 207 bits of useful data in each PD message for the protocol purpose. Vendor defined messages, VDM, may be unstructured VDM messages or structured VDM messages. Unstructured VDM messages may be used in an example, which enables vendor defined content. Structured VDM messages may be used in another example; however, the content should be agreed on and defined, such as standardized messages.

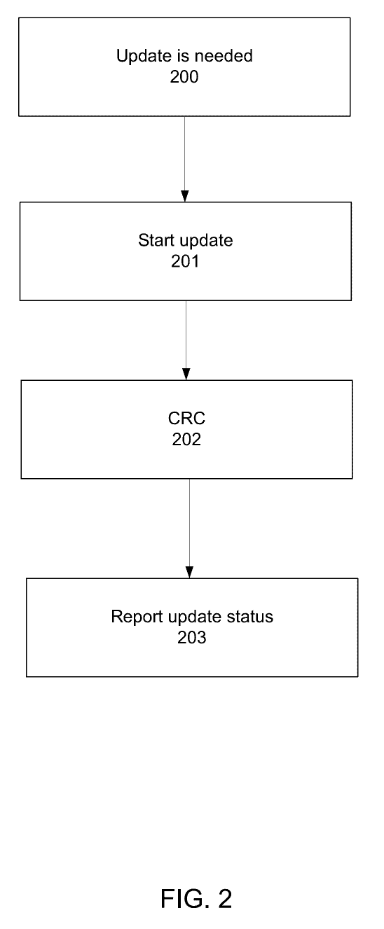

The protocol may, for example, contain the following as illustrated in FIG. 2: Messages to exchange information about the current and new firmware to be able to decide whether updating is needed, in the step 200. Message to start a sequence so that the receiver can expect to get payload data in the following commands, in the step 201. Message to exchange cyclic redundancy check, CRC, information so that the receiver, for example the device 200, knows that is has received all data pieces correctly, in the step 202. Message to report updating status in the step 203. CRC, for example CRC32 over the data, is only an example. One may use SHA256 or any other suitable algorithm alternatively. The transfer data is validated, before taking it in to use. It may be also possible that a new firmware is written to a target memory after each PD message.

According to an example, a secure way, if there is enough space in the target device 200, is to make CRC check over the whole data, before starting to update firmware. Consequently, transfer errors cannot make a device to be broken, due to a missing piece of software update data. If there is not enough space to a new firmware to be held in the memory, then CRC could be done after receiving an amount of data, which equals to the maximum RAM that can be used to store a part of the new firmware, before it is written to target eMMC. According to an example the firmware may be verified, before writing it to eMMC, so that possible transfer errors do not cause harm.

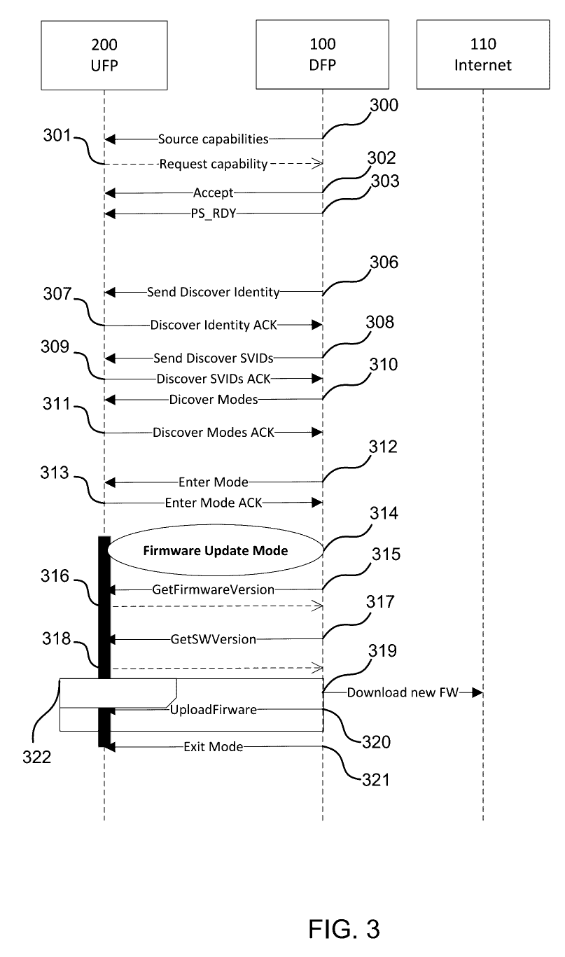

FIG. 3 illustrates a sequence diagram of an example of a method for updating a firmware of a peripheral device 200. FIG. 3 shows how the downstream facing port, DFP, device, for example the device 100, makes a standard power contract and modes identification with the attached upstream facing port, UFP, device, for example the peripheral device 200. Communication is conducted using a USB Type C cable configuration channel CC. At first, the DFP device 100 identifies that the connected UFP device 200 supports a firmware update mode, for example in the steps 300-311. The DFP device 100 commands the UFP device 200 to enter that mode in the step 312. In this mode, for example unstructured VDM messages may be used to get software and firmware information from the UFP device 200 in the steps 314-318. Based on that information, the DFP device 100 downloads new firmware from the Internet in the step 319, for example, from an update server 110. The DFP device 100 sends and updates a new firmware for the UFP device 200 in the step 320.

The following example uses unstructured VDM messages for firmware update operation. As discussed, other kinds of protocols and messages may be used instead of the unstructured VDM messages. Unstructured VDM messages can be defined by a vendor. These messages are allowed to be sent in a mode operation. A device can support multiple of modes. A mode is entered with an enter mode command.

In the step 300, the DFP device 200 sends a source capabilities message to the UFP device 200. In the step 301, the UFP device 200 sends a request capability message to the DFP device 100. The DFP device 100 sends accept and PS_RDY messages to the UFP device 200 in the steps 302 and 303. The request capability message may indicate a capability mismatch, for example that the device cannot select any power level, which is offered in the source capabilities.

The DFP device 100, which is connected to the UFP device 200, can check if modes are supported by sending a Discover Identity message in the step 306. The UFP device 200 acknowledges this in the step 307.

In the step 308, the DFP device 100 sends a discover SVIDs message, and in the step 309 the UFP device 200 acknowledges this. For example, if the UFP device 200 supports modes, the DFP device 100 will then query Discover SVIDs in the step 308. For example, in a discover SVID message UFP device returns a list of SVIDs, which modes the device has. Consequently, if the discover SVID returns a non-empty list of SVIDs, the DFP device already knows that there are modes in the UFP device. In the step 310, the DFP device 100 sends a discover modes message to the UFP device 200, and in the step 311, the UFP device 200 acknowledges this. For example, the DFP device 100 sends the Discover Modes message for each SVID:s that UFP supports to identify all modes, which are supported by the UFP 200 in the step 310. For example, after the discover SVID message a discover Modes command is sent so that SVID value is given in that command. In this phase, the UFP device returns more information about the modes that SVID has.

The DFP device 100 sends an Enter Mode message to the UFP device 200 to enter that mode in the step 312, and the UFP device 200 acknowledges this. For example, if the DFP device 200 detects that the UFP device 100 supports a Firmware Update Mode (a new vendor defined mode for this firmware update operation), it sends an Enter Mode command to the UFP device 200 in the step 312. The UFP device 200 must report Modal Operation Supported bit=1, if the device 200 supports one or more alternative modes, for example Firmware Update mode.

As discussed, there are various protocols as to how unstructured VDM messages are used to upload new firmware to the UFP device 200 from the DFP device 100 in the firmware update mode in the step 314. For example, the DFP device 100 queries a current firmware version and hardware identity from the DFP device 200 in the step 315. The UFP device 100 responds to this in the step 316. In the step 317, the DFP device 200 queries a current software version from the UFP device 200. In the step 318, the UFP device 200 responds to this to the DFP device 100. Based on this information, the DFP device 100 loads new firmware from the Internet in the step 319. When firmware is loaded to the DFP device 200, for example to RAM or eMMC of the DFP device 200, a firmware update operation is started in the step 320. In an example, the steps 319 and consequently 320 may also start much later than the previous steps. The DFP device 100 may silently request the firmware version and hardware information from the UFP device 100. Then, the DFP device 200 may download the firmware when specified network parameters are met, for example WLAN is available. Then, on the next connection to the same hardware of the UFP device 200, the firmware update operation is finalized. In the step 321, the firmware update is ended by sending an Exit Mode message. Firmware update may also be ended so that the target device makes a reset, which automatically means that mode is exited. In the example of FIG. 3, a bolded vertical line illustrates an example of a state, when the device(s) is configured in the update mode.

According to an example, the data transfer speed may be less than 300 kBs. Consequently, the firmware update relating to this speed may relate to relatively simple devices, in which case the firmware is not too large. As discussed, the firmware of the peripheral device 200 is typically small so that a low data transfer speed is feasible. Even if a device firmware would be of a considerable size, a device may be connected for a longer period time. Consequently, it is possible to transfer a firmware image, for examples as a background communications, even using several hours for transmission. This may render update process of large firmware also feasible.

According to an example, the firmware may also be partially updated. For example, a memory contains the firmware update, and a part of the update is performed. The update process may be continued later to finalize the firmware update. In this scenario PD may need to be used to negotiate software parts and each updatable partition of firmware version separately.

According to an example, there may not necessarily be anything connected to another end of the cable plug, but the devices may act partially independent for performing the functions and operations of the examples.

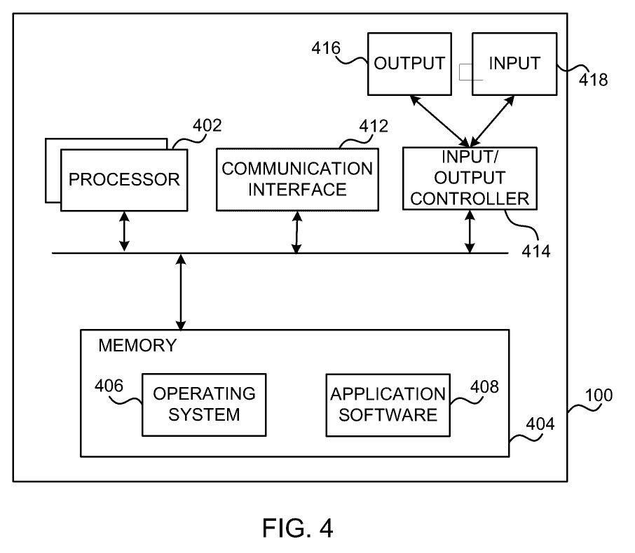

FIG. 4 illustrates an example of components of a computing device 100 which may be implemented as any form of a computing and/or electronic device. The computing device 100 comprises one or more processors 402 which may be microprocessors, controllers or any other suitable type of processors for processing computer executable instructions to control the operation of the apparatus 100. Platform software comprising an operating system 406 or any other suitable platform software may be provided on the apparatus to enable application software 408 to be executed on the device.

Computer executable instructions may be provided using any computer-readable media that are is accessible by the device 100. Computer-readable media may include, for example, computer storage media such as memory 404 and communications media. Computer storage media, such as memory 404, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage medium (the memory 404) is shown within the device 100, it will be appreciated that the storage may be distributed or located remotely and accessed via a network or other communication link (e.g. using a communication interface 412).

In an example, the communication block 102 of FIG. 1 may be established by the communication interface 412 of FIG. 4.

The device 100 may comprise an input/output controller 414 arranged to output information to an output device 416 which may be separate from or integral to the device 100. The input/output controller 414 may also be arranged to receive and process input from one or more input devices 418. In one example, the output device 416 may also act as the input device. The input/output controller 414 may also output data to devices other than the output device, e.g. a locally connected printing device. According to another example, the USB connection block 101, for example as shown in FIG. 1, may be established by a combined input 418 and output 416, working jointly, or by the block 416 acting also as the input device.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The term ‘computer’, ‘computing-based device’, ‘apparatus’ or ‘mobile apparatus’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods and functionalities described herein may be performed by software in machine readable form on a tangible storage medium e.g. in the form of a computer program comprising computer program code means adapted to perform all the functions and the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought. Also any example may be combined to another example unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

According to the above, some examples are directed to a method, comprising: communicating from a first device to a second device by a configuration channel of a universal serial bus; identifying, by the first device, that the second device supports a firmware update mode for an update of a firmware of the second device; commanding, by the first device, the second device to enter the firmware update mode; receiving, by the first device, information of the firmware from the second device; based on the received firmware information, obtaining, by the first device, the update of the firmware; and sending, by the first device, the update of the firmware to the second device, wherein the steps of identifying, commanding, receiving, and sending are conducted by the communication via the configuration channel of the universal serial bus. Additionally or alternatively to one or more of the examples, the configuration channel of the universal serial bus is configured to further agree on a mutual power contract between the devices. Additionally or alternatively to one or more of the examples, a universal serial bus Type c comprises the configuration channel. Additionally or alternatively to one or more of the examples, the devices are connected via the configuration channel of a universal serial bus Type c cable. Additionally or alternatively to one or more of the examples, the cable includes two configuration channel wires, and one of the wires is configured for the communication via the configuration channel. Additionally or alternatively to one or more of the examples, a data communication channel of the cable is not supported by the second device. Additionally or alternatively to one or more of the examples, unstructured vendor defined messages are used in the communication via the configuration channel. Additionally or alternatively to one or more of the examples, further comprising exchanging information about a current version of the firmware and a new version of the firmware to decide whether the update is needed. Additionally or alternatively to one or more of the examples, connecting, by the first device, to the Internet. Additionally or alternatively to one or more of the examples, receiving, by the first device, the update of the firmware from the Internet. Additionally or alternatively to one or more of the examples, downloading, by the first device, the update of the firmware from a server via the Internet. Additionally or alternatively to one or more of the examples, further comprising receiving, by the first device, the update of the firmware from a storage medium. Additionally or alternatively to one or more of the examples, the second device does not have an Internet capability. Additionally or alternatively to one or more of the examples, querying, by the device, a current version of the firmware of the second device. Additionally or alternatively to one or more of the examples, downloading, by the first device, the update of the firmware based on the query. Additionally or alternatively to one or more of the examples, executing the update of the firmware on the second device by the configuration channel without user interaction. Additionally or alternatively to one or more of the examples, further comprising receiving, by the second device, the firmware; and performing, by the second device, the update of the firmware at a boot operation of the second device. Additionally or alternatively to one or more of the examples, the update of the firmware comprises a partial update, and performing the update stepwisely.

Some examples are directed to a computer-readable storage medium comprising executable instructions for causing at least one processor of a computing apparatus to perform operations comprising: communicate from a first device to a second device by a configuration channel of a universal serial bus; identify that the second device supports a firmware update mode for an update of a firmware of the second device; command the second device to enter the firmware update mode; receive information of the firmware from the second device; based on the received firmware information, obtain the update of the firmware; and send the update of the firmware to the second device.

Some examples are directed to a device, comprising: at least one processor, and at least one memory storing program instructions that, when executed by the at least one processor, cause the device to: communicate from the device to another device by a configuration channel of a universal serial bus; identify, by the device, that the other device supports a firmware update mode for an update of a firmware of the other device; command, by the device, the other device to enter the firmware update mode; receive, by the device, information of the firmware from the other device; based on the received firmware information, obtain, by the device, the update of the firmware; and send, by the device, the update of the firmware to the other device.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A method, comprising:
communicating from a first device to a second device by a configuration channel of a universal serial bus;
identifying, by the first device, that the second device supports a firmware update mode for an update of a firmware of the second device;
commanding, by the first device, the second device to enter the firmware update mode;
receiving, by the first device, information of the firmware from the second device;
based on the received firmware information, obtaining, by the first device, the update of the firmware; and
sending, by the first device, the update of the firmware to the second device,
wherein the steps of identifying, commanding, receiving, and sending are conducted by the communication via the configuration channel of the universal serial bus.

2. The method of claim 1, wherein the configuration channel of the universal serial bus is configured to further agree on a mutual power contract between the devices.

3. The method of claim 1, wherein a universal serial bus Type C comprises the configuration channel.

4. The method of claim 1, wherein the devices are connected via the configuration channel of a universal serial bus Type C cable.

5. The method of claim 4, wherein the cable includes two configuration channel wires, and one of the wires is configured for the communication via the configuration channel.

6. The method of claim 4, wherein a data communication channel of the cable is not supported by the second device.

7. The method of claim 1, wherein unstructured vendor defined messages are used in the communication via the configuration channel.

8. The method of claim 1, further comprising exchanging information about a current version of the firmware and a new version of the firmware to decide whether the update is needed.

9. The method of claim 1, connecting, by the first device, to the Internet.

10. The method of claim 9, receiving, by the first device, the update of the firmware from the Internet.

11. The method of claim 9, downloading, by the first device, the update of the firmware from a server via the Internet.

12. The method of claim 1, further comprising receiving, by the first device, the update of the firmware from a storage medium.

13. The method of claim 1, wherein the second device does not have an Internet capability.

14. The method of claim 1, querying, by the device, a current version of the firmware of the second device.

15. The method of claim 14, downloading, by the first device, the update of the firmware based on the query.

16. The method of claim 1, executing the update of the firmware on the second device by the configuration channel without user interaction.

17. The method of claim 1, further comprising receiving, by the second device, the firmware; and performing, by the second device, the update of the firmware at a boot operation of the second device.

18. The method of claim 1, wherein the update of the firmware comprises a partial update, and performing the update stepwisely.

19. A computer-readable storage medium comprising executable instructions for causing at least one processor of a computing apparatus to perform operations comprising:
communicate from a first device to a second device by a configuration channel of a universal serial bus;
identify that the second device supports a firmware update mode for an update of a firmware of the second device;
command the second device to enter the firmware update mode;
receive information of the firmware from the second device;
based on the received firmware information, obtain the update of the firmware; and
send the update of the firmware to the second device.

20. A device, comprising:
at least one processor, and
at least one memory storing program instructions that, when executed by the at least one processor, cause the device to:
communicate from the device to another device by a configuration channel of a universal serial bus;
identify, by the device, that the other device supports a firmware update mode for an update of a firmware of the other device;
command, by the device, the other device to enter the firmware update mode;
receive, by the device, information of the firmware from the other device;
based on the received firmware information, obtain, by the device, the update of the firmware; and
send, by the device, the update of the firmware to the other device.
